(19) United States
(12) Patent Application Publication
(10) Pub. No.: US 2023/0225376 A1
(43) Pub. Date: Jul. 20, 2023

(54) Freezer Bag Block Maker

(71) Applicant: YouCopia Products, Inc., Chicago, IL (US)

(72) Inventor: Mark Greenwood, Evanston, IL (US)

(73) Assignee: YouCopia Products, Inc., Chicago, IL (US)

(21) Appl. No.: 18/154,908

(22) Filed: Jan. 16, 2023

Related U.S. Application Data
(60) Provisional application No. 63/266,850, filed on Jan. 17, 2022.

(51) Int. Cl. A23L 3/36; B65D 33/02

(52) U.S. Cl. CPC A23L 3/364; B65D 33/02

(57) ABSTRACT

A freezer bag block maker includes two container portions that are removably attachable to form a container. The two container portions are attached along an interface which divides the container into two equal portions along a short side of the container. One or more fasteners such as elastomeric bands join the container portions together such as by surrounding the container portions. A plastic bag is insertable into an interior space defined by the container to retain a food item within the bag in a desired shape as the food item freezes. The bag and frozen items may then be removed from the bag, having the desired frozen shape.

### BACKGROUND OF THE INVENTION

It can be very useful to freeze certain liquids or viscous foods for storage and later use. For example, broths and juices can be frozen and stored for later use. Other generally viscous foods may be considered “liquids” for this purpose because they will flow and are not solid, such as soups, stews, smoothies, sauces, and baby foods. Similarly, a collection of small particulate solid foods such as berries can be frozen for storage, and within this specification such items will be treated as being viscous because the separate particles are essentially flowable. Currently, consumers may place the liquid (or other food item or items) in a container such as a food storage container, or an ice cube tray type of container, freezing the liquid into a frozen shape that matches the shape of the container or tray. It can sometimes be useful to store and freeze such liquids in a plastic bag having a zipper seal, but plastic storage bags do not sit upright on their own when containing a liquid, and even when lying flat they may cause the liquid to freeze in an imperfect or less than desirable shape. The typical freezer may not have a flat space available, thereby preventing a person from placing a bag in a freezer while the food item is in the liquid state in order to produce a generally flat frozen shape. In addition, any imperfection in the closure of the bag may produce a leak which may cause problems until the liquid is frozen.

### SUMMARY OF THE INVENTION

A freezer bag block maker is generally configured as a narrow rectangular cubic container having an interior space that is dimensioned to receive a plastic storage bag. In a preferred version, the container is formed in two portions which may be fully separated from one another. The two container portions, preferably dimensioned as halves, join together along an interface which may be configured with a number of tab and slot features to allow the two halves to interlock with one another. The two container portions may further be secured to one another with a fastener, and in one version the fastener is configured as one or more resilient bands which removably encircle the two portions. The container may be produced in varying sizes, to accommodate plastic storage bags of different sizes.

In one version, the freezer bag block maker includes a container having a first container portion and a second container portion, the first container portion being removably attachable to the second container portion to define the container, the container having a base and an upwardly extending sidewall terminating in a rim.

The container further defines an interior space arranged to receive a plastic bag, the container having a container width which is greater than a container depth, and a container height extending from the base to the rim which is greater than the container depth. A first elastomeric band is removably attachable to the container to surround the sidewall at a location between the rim and the base, whereby the first elastomeric band urges the first container portion against the second container portion when the first elastomeric band is attached to the container and surrounding the sidewall.

An abutment is positioned on the sidewall, the abutment being positioned to define a location for the first elastomeric band when the first elastomeric band is attached to the container and surrounding the sidewall.

In some versions, the sidewall includes a first channel and the abutment comprises a first abutment and a second abutment defining opposite sides of the first channel, the channel being sized to receive and retain the first elastomeric band within the first channel.

Preferably, the sidewall includes a second channel and a second elastomeric band, the first channel and the second channel being spaced apart from one another between the rim and the base, whereby the second elastomeric band is removably attachable to the container to surround the sidewall at a location between the rim and the base, the second elastomeric band urging the first container portion against the second container portion when the second elastomeric band is attached to the container and surrounding the sidewall.

In preferred versions, a first post is positioned within the first channel and extending outwardly from the sidewall, the first elastomeric band further having a first through-hole wherein the first post is removably receivable within the first through-hole to removably mount the first elastomeric band on the first post.

Likewise, in some versions a second post is positioned within the second channel and extending outwardly from the sidewall, the second elastomeric band further having a second through-hole wherein the second post is removably receivable within the second through-hole to removably mount the second elastomeric band on the second post.

Most preferably, the freezer bag block maker is used by inserting the plastic bag into the interior space, filling the plastic bag with a viscous food item, either before or after inserting the plastic bag into the interior space, freezing the container and the plastic bag, and removing the plastic bag from the interior space.

Ideally, the first elastomeric band is removed from the sidewall and the first container portion is removed from the second container portion before removing the plastic bag from the interior space.

In some versions, the freezer bag block maker includes a container having a first container portion and a second container portion, the first container portion being removably attachable to the second container portion to define the container, the container having a base and an upwardly extending sidewall terminating in a rim. The container further defines an interior space arranged to receive a plastic bag, the container having a container width which is greater than a container depth, and a container height extending from the base to the rim which is greater than the container depth. When the first container portion is attached to the second container portion, the first container portion and the second container portion define an interface, the interface extending from the rim, along the sidewall, and through the base of the container. A first fastener is positioned on the sidewall and configured to releasably attach the first container portion to the second container portion, and a second fastener is positioned on the sidewall and configured to releasably attach the first container portion to the second container portion.

Most preferably, the first container portion and the second container portion each define a half of the container.

In preferred versions, the sidewall defines a pair of opposing width sides along the container width and a pair of opposing depth sides along the container depth, the interface extending along from the rim to the base through the pair of opposing depth sides. A first post may be positioned on the sidewall and extending outwardly from the sidewall, the first elastomeric band being mountable on the first post.

### BRIEF DESCRIPTION OF THE DRAWINGS

Preferred and alternative examples of the present invention are described in detail below with reference to the following drawings.

FIG. 1 is a front top perspective view of a pair of freezer bag block makers, including one dimensioned to receive a gallon-size plastic bag and one dimensioned to receive a quart-size plastic bag.

FIG. 2 is a top perspective view of a preferred freezer bag block maker.

FIG. 3 is an exploded view of a preferred freezer bag block maker.

FIG. 4 is an exploded view of a preferred freezer bag block maker, shown without resilient bands.

FIG. 5 is a front elevational view of one of a pair of container portions forming a preferred freezer bag block maker.

FIG. 6 is a front elevational view as in FIG. 5, shown with a representative plastic bag inserted.

FIG. 7 is a sectional view taken through section plane 7-7 in FIG. 2.

FIG. 8 is an illustration of a preferred freezer bag block maker with a freezer bag inserted and a liquid being poured into the bag.

FIG. 9 is a front elevational view of a preferred freezer bag block maker, shown with a bag inserted and one of a pair of resilient bands removed from a channel on the container.

FIG. 10 is a front elevational view of a preferred freezer block bag maker after a liquid has been frozen, shown with a first container portion removed from a second container portion.

### DETAILED DESCRIPTION OF THE PREFERRED EMBODIMENT

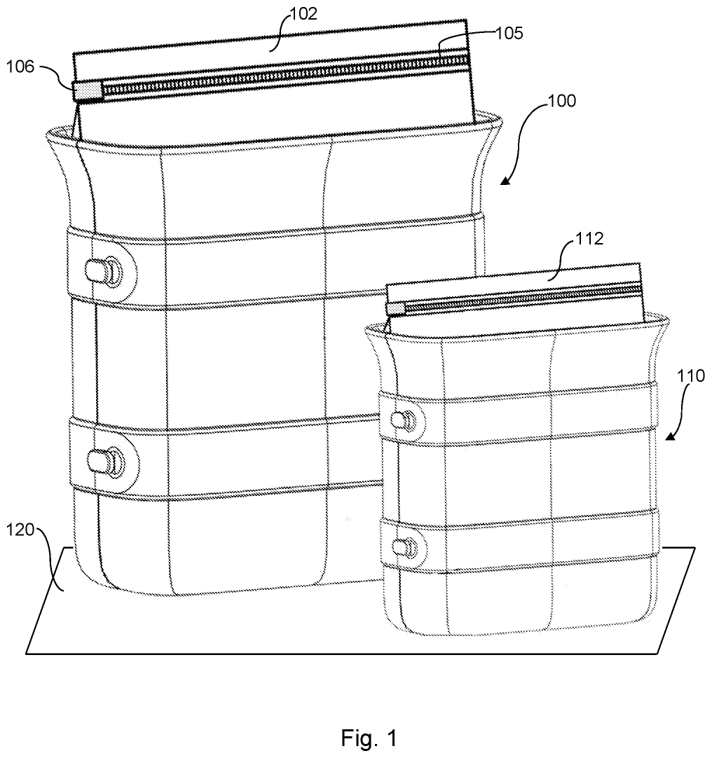

An exemplary preferred freezer bag block maker is shown in FIG. 1. As illustrated, there are two freezer bag block makers, including a large version 100 dimensioned to receive and hold a gallon-sized plastic storage bag 102, and a smaller version 110 dimensioned to receive and hold a quart-sized plastic storage bag 112. It should be appreciated that other sizes are also possible, and that an interior volume of a container forming the freezer bag block maker need not conform to the size of a particular plastic bag volume. The storage bag 102 is illustrated as having a zipper closure 105 including a zipper pull 106. Bags having other forms of closures, or no closure at all, may also be used for containing the liquid item. The freezer bag block makers are illustrated resting on a horizontal surface 120, which is illustrated as a countertop.

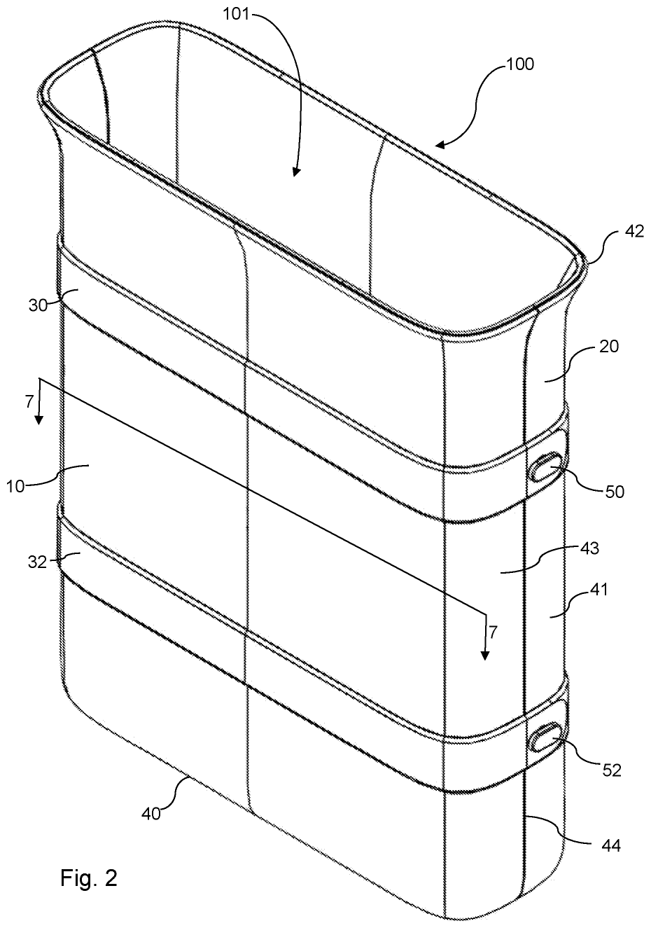

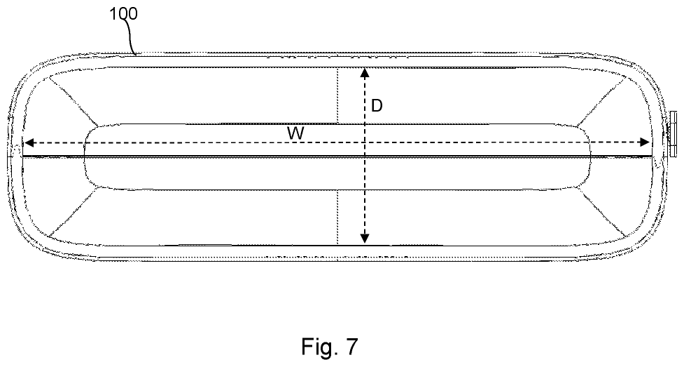

A single freezer bag block maker is shown in a perspective view in FIG. 2. As illustrated, the freezer bag block maker is configured as a container 100 having a first container portion 10 and a second container portion 20 removably joined together along a generally planar seam 44 to define an interior volume 101. In the illustrated example, the first and second container portions 10, 20 are each substantially identical in size, thereby each forming container halves. The container includes a base 40 at the bottom of the container, arranged to allow the container to be supported on a horizontal surface such as the countertop 120 shown in FIG. 1. A sidewall 41, 43 extends upwardly from the base, terminating in a rim 42. Section plane 7-7 in FIG. 2 is taken horizontally through a location midway between the base and the rim, and the corresponding section view is illustrated in FIG. 7. As seen in FIG. 7, the container preferably is formed with a width W which is much larger than a depth D, and in a preferred example the width is about three times greater than the depth.

As seen in FIG. 2, the first portion and second portion are joined together by one or more fasteners, which preferably are in the form of one or more resilient bands. The resilient bands are preferably formed from an elastomeric material, such as silicone, rubber, or some other thermoplastic elastomer. In the preferred version two resilient bands 30, 32 are provided. Each one of the bands is attached to a corresponding post 50, 52 positioned on one or the other of the container portions. Although in the preferred version each container portion forms one half of the container, in alternate versions one of the container portions may be larger than the other.

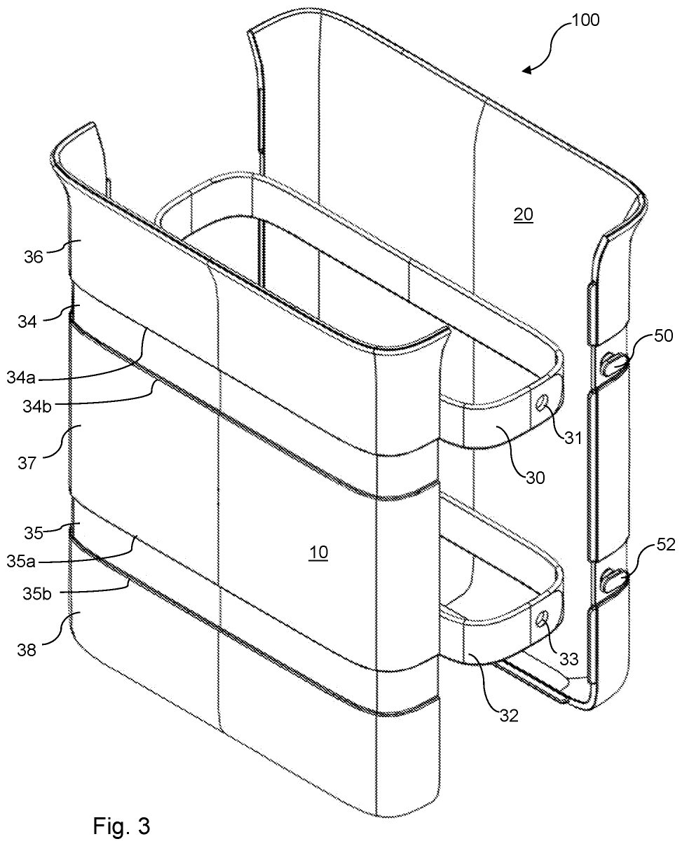

FIG. 3 shows an exploded view of the freezer bag block maker. A first container portion 10 is shown having a lower section 38, a middle section 37, and an upper section 36. A pair of recessed channels separates the three sections, including an upper channel 34 and a lower channel 35. A second container portion 20 is configured in the same manner, though the channels are not visible in this illustration. Each channel provides a pair of abutments 34a, 34b and 35a, 35b along the opposing sides of the channels to retain a band in place about the container. Although recessed channels are incorporated into the outer surfaces of the container portions in the illustrated example, in other versions the channels may be omitted, or alternatively raised surface abutments may be provided to serve as guides to hold resilient bands in place, as explained below.

The second container portion includes a pair of posts 50, 52, positioned on one end of the container portion, each seated within one of the upper channel and the lower channel. In accordance with a preferred version, the first container portion 10 is identical to the second container portion 20 except for the inclusion of the posts 50, 52, which are provided on only one of the two container portions. In other versions, the posts may be provided in other locations or may be arranged with one post on each of the two container portions.

A pair of resilient bands 30, 32 are shown in FIG. 3, separated from the container portions and removed from the channels. Each band preferably includes a hole 31, 33 sized to receive one of the posts 50, 52. Each post terminates in a head which will retain the band on the post when the head and the post is inserted into a corresponding hole in one of the bands. Accordingly, one of the posts holds a band onto one of the container portions while allowing the band to be removed from the corresponding channel so that the container portions may be separated from one another while leaving the band mounted on the post.

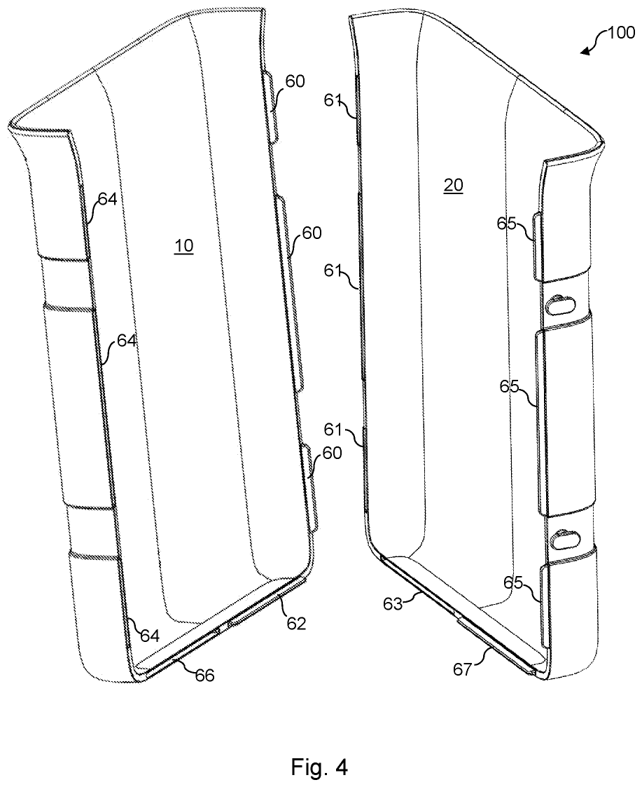

FIG. 4 is an exploded view of the freezer bag block maker, in this case showing only the two container portions and not including the resilient bands. As shown, each container portion includes one or more tabs and slots to aid in connecting the container portions to one another in a proper alignment. In a preferred version, the first container portion 10 includes a series of three tabs 60 along one side and another tab 62 at a bottom edge at the base. It further includes a series of three slots 64 along an opposing side and a slot 66 at the bottom edge of the base. The second container portion 20 has the identical arrangement, such that when the two portions are facing one another as shown, the second container portion includes a series of three slots 61 aligned with the series of three tabs 60. At the base, the second container portion includes a slot 63 and a tab 67 sized and arranged to mate with the tab 62 and slot 66 of the first container portion. Along the opposite side, the second container portion includes a series of three tabs 65 sized and arranged to mate with the three slots 64 of the first container portion. The two portions thus may be secured to one another by joining the tabs and slots, providing a frictional connection.

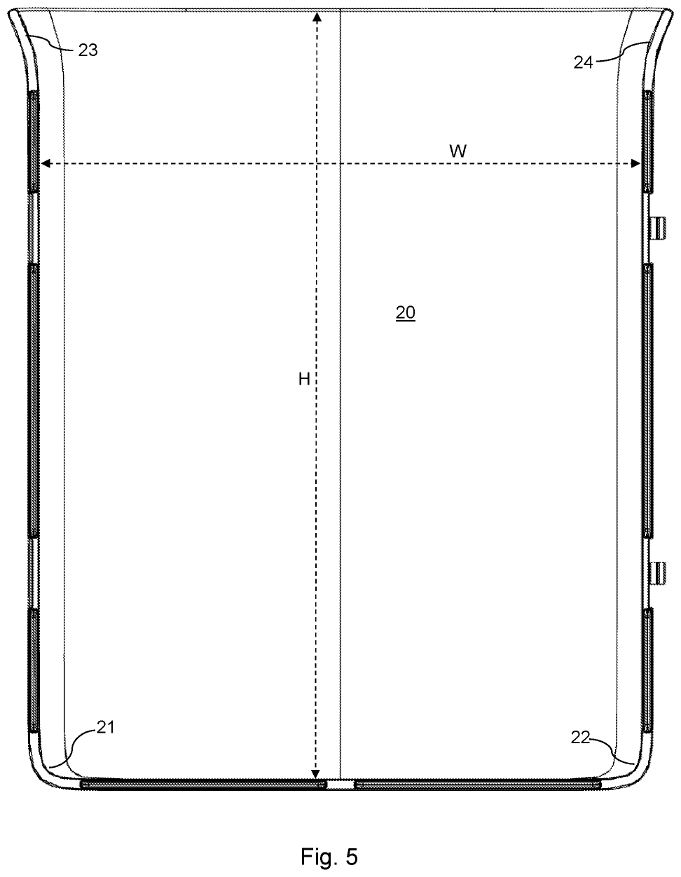

FIG. 5 is a front elevational view of the second container portion 20, shown from a perspective looking into the portion of the container volume defined by the second container portion. This illustration shows a preferred dimension for the container, in which the base and sidewall define a rectangular shape having rounded bottom corners 21, 22 and a flared upper end 23, 24. In the preferred version, a height H of the container is greater than a width W.

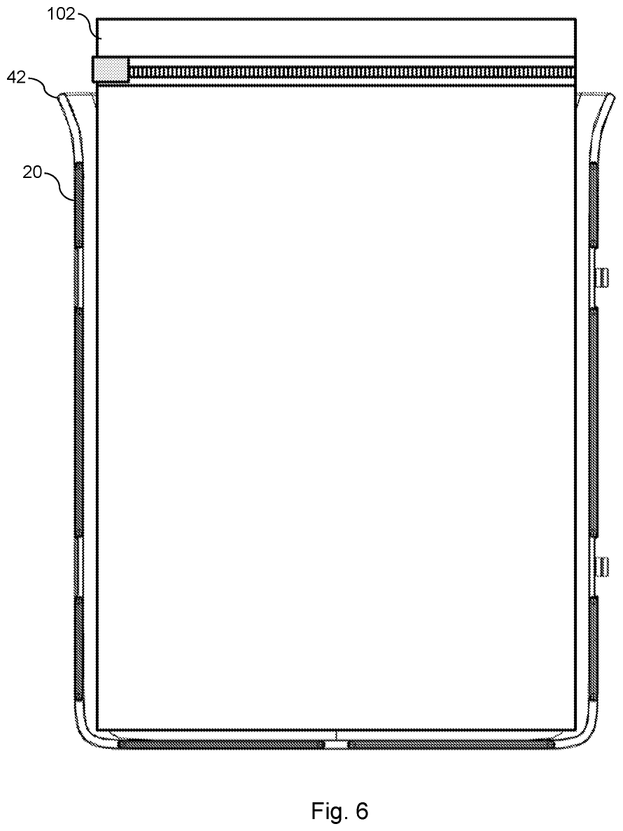

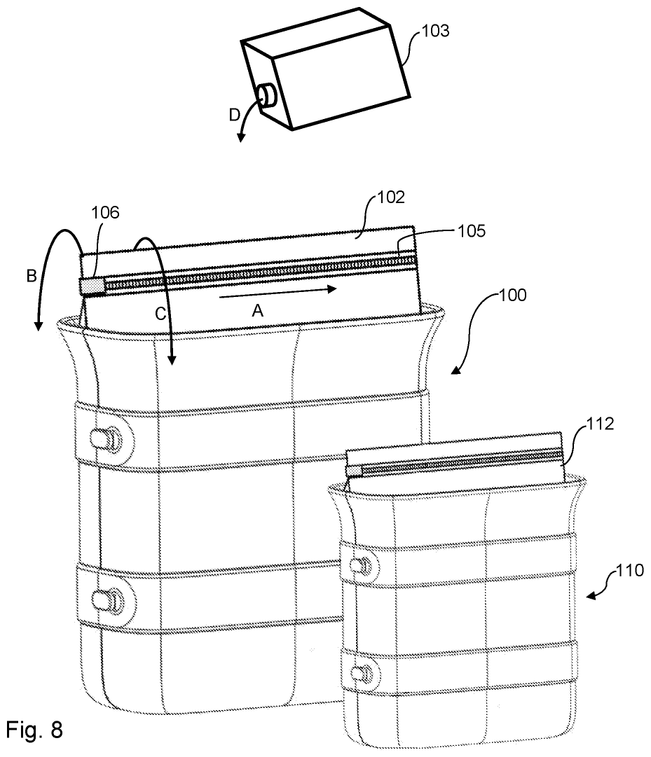

FIG. 6 shows the same front elevational view as in FIG. 5, but in this case with an exemplary plastic freezer bag 102 inserted. As shown, preferably the container is dimensioned to snugly receive the bag within the sidewall. In addition, in one version, as illustrated, the container is shorter than the height of the bag. This arrangement allows the bag to be inserted while empty, and the mouth of the bag to be rolled downward, over the rim of the container, so that the bag can be filled while the bag is inside the container, as indicated in FIG. 8.

FIG. 7 is a top sectional view, showing a preferred depth D and width W for a freezer bag block maker, as described above.

A preferred use of the freezer bag block maker is shown with reference to FIGS. 8-10. In FIG. 8, a freezer bag 102 is inserted into the container 100. As shown, the two container portions are secured to one another and the resilient bands are mounted within the corresponding channels to hold the container portions against one another. The zipper pull 106 is moved in the direction of the arrow A to open the top of the freezer bag (or the bag is otherwise opened at the top, in the case of a differently configured bag). The top end of the freezer bag is then inverted and rolled down around the outside surface of the sidewall of the container, as indicated by arrows B and C, to allow liquid to easily be poured into the bag without getting the liquid in the space between the bag and the container. The liquid 103 (such as broth or juice) is shown being poured into the bag along the path indicated by arrow D.

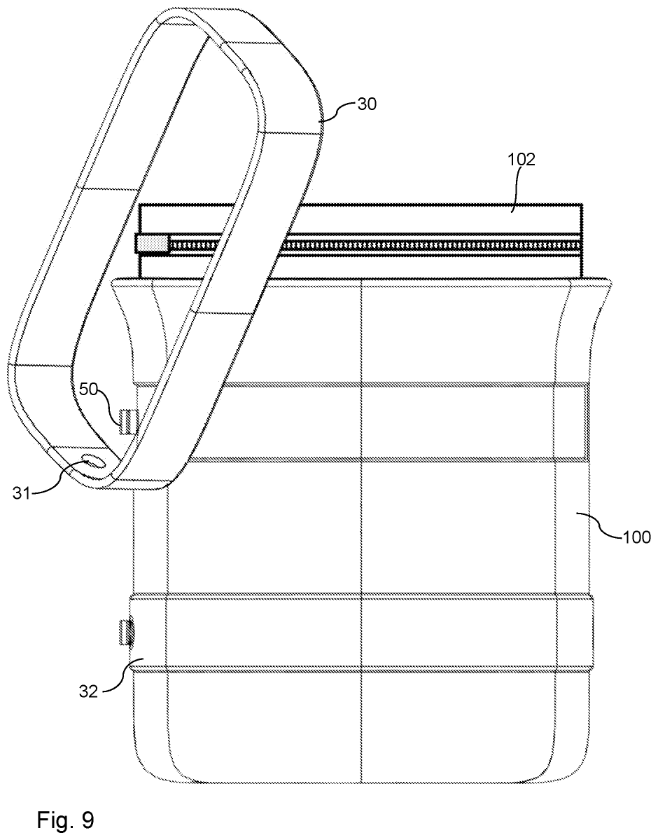

When the bag is filled, it can be sealed such as shown in FIG. 9. This figure also illustrates the functionality of the bands, in which the upper band 30 is shown removed from the channel formed in the sidewall of the container. As noted above, it should be appreciated that in some versions of the invention the channels may be omitted such that there is no channel at all, or in which there is another retention feature such as a raised abutment. The upper band is shown removed from the post 50, although it could be removed but retained on the post and thus still attached to the container. The lower band 32 is shown seated within the channel and surrounding the container, but it may also be removed in the same fashion as shown with the upper band. This allows the bands to be moved out of the way in order to separate the two container portions for easier removal of the bag once the liquid is frozen. It also allows the container to be washed as two separate portions.

Once the liquid is inserted and the bands are in position surrounding the container, the assembly can be placed in a freezer. The liquid may expand during the freezing process, causing the two container portions move outward from one another (expanding the size of the interior volume). The frictional engagement of the tabs and slots allows the two container portions to move toward or away from one another, while the resilient bands will retain the two container portions against one another even as they allow some outward movement from expansion.

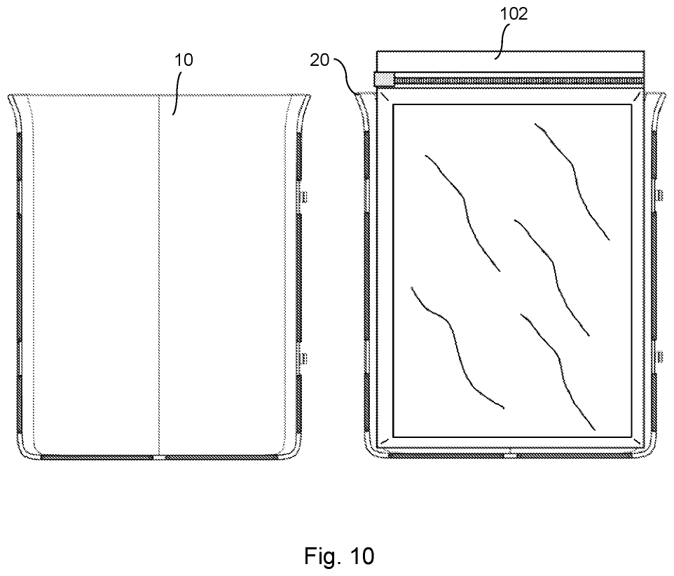

FIG. 10 shows the second container portion fully removed from the first container portion 10, and the interior freezer bag 102 with its frozen contents seated within the second container portion 20. The frozen contents will form a shape constrained by the dimensions of the interior space of the container, such that a substantially full bag will freeze to a cubic planar shape.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims.

I claim:

1. A freezer bag block maker, comprising:
a container having a first container portion and a second container portion, the first container portion being removably attachable to the second container portion to define the container, the container having a base and an upwardly extending sidewall terminating in a rim;
the container further defining an interior space arranged to receive a plastic bag, the container having a container width which is greater than a container depth, and a container height extending from the base to the rim which is greater than the container depth;
a first elastomeric band, the first elastomeric band being removably attachable to the container to surround the sidewall at a location between the rim and the base, whereby the first elastomeric band urges the first container portion against the second container portion when the first elastomeric band is attached to the container and surrounding the sidewall; and
an abutment positioned on the sidewall, the abutment being positioned to define a location for the first elastomeric band when the first elastomeric band is attached to the container and surrounding the sidewall.

2. The freezer bag block maker of claim 1, wherein the sidewall further comprises a first channel and the abutment comprises a first abutment and a second abutment defining opposite sides of the first channel, the channel being sized to receive and retain the first elastomeric band within the first channel.

3. The freezer bag block maker of claim 2, further comprising a second channel and a second elastomeric band, the first channel and the second channel being spaced apart from one another between the rim and the base, whereby the second elastomeric band is removably attachable to the container to surround the sidewall at a location between the rim and the base, the second elastomeric band urging the first container portion against the second container portion when the second elastomeric band is attached to the container and surrounding the sidewall.

4. The freezer bag block maker of claim 3, further comprising a first post positioned within the first channel and extending outwardly from the sidewall, the first elastomeric band further having a first through-hole wherein the first post is removably receivable within the first through-hole to removably mount the first elastomeric band on the first post.

5. The freezer bag block maker of claim 4, further comprising a second post positioned within the second channel and extending outwardly from the sidewall, the second elastomeric band further having a second through-hole wherein the second post is removably receivable within the second through-hole to removably mount the second elastomeric band on the second post.

6. The freezer bag block maker of claim 1, further comprising a first post positioned on the sidewall and extending outwardly from the sidewall, the first elastomeric band further having a first through-hole wherein the first post is removably receivable within the first through-hole to removably mount the first elastomeric band on the first post.

7. A method of using the freezer bag block maker of claim 1, comprising:
inserting the plastic bag into the interior space;
filling the plastic bag with a viscous food item, either before or after inserting the plastic bag into the interior space;
freezing the container and the plastic bag; and
removing the plastic bag from the interior space.

8. The method of claim 7, further comprising removing the first elastomeric band from the sidewall and removing the first container portion from the second container portion before removing the plastic bag from the interior space.

9. A freezer bag block maker, comprising:
a container having a first container portion and a second container portion, the first container portion being removably attachable to the second container portion to define the container, the container having a base and an upwardly extending sidewall terminating in a rim;
the container further defining an interior space arranged to receive a plastic bag, the container having a container width which is greater than a container depth, and a container height extending from the base to the rim which is greater than the container depth;
wherein when the first container portion is attached to the second container portion, the first container portion and the second container portion define an interface, the interface extending from the rim, along the sidewall, and through the base of the container;
a first fastener, the first fastener being positioned on the sidewall and configured to releasably attach the first container portion to the second container portion; and
a second fastener, the second fastener being positioned on the sidewall and configured to releasably attach the first container portion to the second container portion.

10. The freezer bag block maker of claim 9, wherein the first container portion and the second container portion each define a half of the container.

11. The freezer bag block maker of claim 10, wherein the sidewall defines a pair of opposing width sides along the container width and a pair of opposing depth sides along the container depth, the interface extending along from the rim to the base through the pair of opposing depth sides.

12. The freezer bag block maker of claim 11, wherein the first fastener comprises a first elastomeric band.

13. The freezer bag block maker of claim 12, wherein the second fastener comprises a second elastomeric band.

14. The freezer bag block maker of claim 13, further comprising a first post positioned on the sidewall and extending outwardly from the sidewall, the first elastomeric band being mountable on the first post.

15. A method of using the freezer bag block maker of claim 11, comprising:
inserting the plastic bag into the interior space;
filling the plastic bag with a viscous food item, either before or after inserting the plastic bag into the interior space;
freezing the container and the plastic bag; and
removing the plastic bag from the interior space.

16. The method of claim 15, further comprising releasing the first fastener and removing the first container portion from the second container portion before removing the plastic bag from the interior space.

17. The method of claim 16, wherein the first fastener comprises a first elastomeric band and the second fastener comprises an elastomeric band, and wherein releasing the first fastener comprises removing the first elastomeric band and the second elastomeric band from the container.
